(19) United States
(12) Patent Application Publication
(10) Pub. No.: US 2024/0423225 A1
(43) Pub. Date: Dec. 26, 2024

(54) PACKAGED FISH MEAT, FROZEN MINCED FISH MEAT, AND METHOD FOR PREVENTING AGGLUTINATION OF FROZEN MINCED FISH MEAT

(71) Applicant: NISSUI CORPORATION, Tokyo (JP)

(72) Inventor: Takahiro OOBA, Tokyo (JP)

(73) Assignee: NISSUI CORPORATION, Tokyo (JP)

(21) Appl. No.: 18/823,976

(22) Filed: Sep. 4, 2024

Related U.S. Application Data
(63) Continuation of application No. PCT/JP2023/006928, filed on Feb. 27, 2023.

(30) Foreign Application Priority Data
Mar. 7, 2022 (JP) 2022-034176

(51) Int. Cl. A23B 4/16; A23B 4/06; A23L 17/00; B65D 81/18

(52) U.S. Cl. CPC A23B 4/16; A23B 4/06; A23L 17/00; B65D 81/18

(57) ABSTRACT

Packaged fish meat, including: frozen minced fish meat and gas containing oxygen at 22% by volume or more as contents; frozen minced fish meat, wherein the amount of agglutinated frozen minced fish meat based on the entire amount of the frozen minced fish meat is 9.5% by mass or less; or a method for preventing the agglutination of frozen minced fish meat, wherein frozen minced fish meat is made to coexist with gas containing oxygen at 22% by volume or more.

### CROSS REFERENCE TO RELATED APPLICATIONS

The present application is a continuation application of International Patent Application No. PCT/JP2023/006928 filed on Feb. 27, 2023, which claims the benefit of Japanese Patent Application No. 2022-034176, filed on Mar. 7, 2022. The contents of these applications are incorporated herein by reference in their entirety.

### BACKGROUND

The present disclosure relates to packaged fish meat, frozen minced fish meat, and a method for preventing agglutination of the frozen minced fish meat.

Since frozen minced fish meat is in a form to be easily used for cooking for consumers, frozen minced fish meat has been developed in recent years for improving the amount of fish meat consumed. When cooking hamburger steaks or other similar dishes using minced fish meat, the texture improves compared to using ground fish meat, thus it is expected that the range of utilization of fish meat will expand. For example, in International Publication No. WO 2017/170420, it is disclosed that frozen minced fish meat with a specified shape is used for producing high-quality frozen minced fish meat by an easy method.

Particles of frozen minced fish meat are likely to be agglutinated to each other in package containers during frozen storage. Therefore, frozen minced fish meat is sometimes insufficiently individualized when the package is opened for use in cooking, and thus improvement is required mainly from the viewpoint of convenience for consumers.

The present disclosure is related to providing packaged fish meat in which the agglutination of frozen minced fish meat as a content is suppressed, frozen minced fish meat in which the agglutination of the frozen minced fish meat is suppressed, and a method for preventing the agglutination of frozen minced fish meat.

### SUMMARY

The present disclosure includes each of the following contents.
[1] Packaged fish meat, containing frozen minced fish meat and gas as contents, wherein the gas contains oxygen at 22% by volume or more.
[2] The packaged fish meat of [1], wherein the gas contains oxygen at 30% by volume or more.
[3] The packaged fish meat of [1] or [2], wherein the gas contains inert gas if the gas contains a gaseous body other than oxygen.
[4] The packaged fish meat of any of [1] to [3], wherein the frozen minced fish meat has a number average minor axis of 1 to 22 mm.
[5] The packaged fish meat of any of [1] to [4], wherein an amount of agglutinated frozen minced fish meat based on the entire amount of the frozen minced fish meat is 9.5% by mass or less.
[6] The packaged fish meat of any of [1] to [5], wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.
[7] The packaged fish meat of any of [1] to [6], wherein the packaged fish meat is packaged in a package container having a tray and/or a film made of at least one material selected from the group consisting of polyethylene, polypropylene, polyethylene terephthalate, polyamides, an ethylene-vinyl alcohol copolymer, and aluminum.
[8] Frozen minced fish meat, wherein the frozen minced fish meat is covered with gas containing oxygen at 22% by volume or more.
[9] The Frozen minced fish meat of [8], wherein the gas contains oxygen at 30% by volume or more.
[10] The frozen minced fish meat of [8] or [9], wherein the gas contains inert gas if the gas contains a gaseous body other than oxygen.
[11] The frozen minced fish meat of any of [8] to [10], wherein the frozen minced fish meat has a number average minor axis of 1 to 22 mm.
[12] The frozen minced fish meat of any of [8] to [11], wherein an amount of agglutinated frozen minced fish meat based on the entire amount of the frozen minced fish meat is 9.5% by mass or less.
[13] The frozen minced fish meat of any of [8] to [12], wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.
[14] Frozen minced fish meat, wherein an amount of agglutinated frozen minced fish meat based on the entire amount of the frozen minced fish meat is 9.5% by mass or less.
[15] The frozen minced fish meat of [14], wherein unagglutinated frozen minced fish meat has a number average minor axis of 3 to 7 mm, and the agglutinated frozen minced fish meat does not pass through a sieve with an aperture of 7 to 8 mm.
[16] The frozen minced fish meat of [15], wherein the sieve is a round stainless-steel sieve with a size of 30 cm in diameter and 7 cm in height, a minimum aperture of 7 mm, and a maximum aperture of 8 mm.
[17] The frozen minced fish meat of any of [14] to [16], wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.
[18] A method for preventing agglutination of frozen minced fish meat, wherein frozen minced fish meat is made to coexist with gas containing oxygen at 22% by volume or more.
[19] The method of [18], wherein the gas contains oxygen at 30% by volume or more.
[20] The method of [18] or [19], wherein the gas contains inert gas if the gas contains a gaseous body other than oxygen.
[21] The method of any of [18] to [20], wherein the frozen minced fish meat has a number average minor axis of 1 to 22 mm.
[22] The method of any of [18] to [21], wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.
[23] The method of any of [18] to [22], wherein the frozen minced fish meat is made to coexist with the gas in a package container.
[24] The method of [23], wherein the package container contains a tray and/or a film made of at least one material selected from the group consisting of polyethylene, polypropylene, polyethylene terephthalate, polyamides, an ethylene-vinyl alcohol copolymer, and aluminum.
[25] Use of gas containing oxygen at 22% by volume or more for preventing agglutination of frozen minced fish meat.
[26] The use of [25], wherein the gas contains oxygen at 30% by volume or more.
[27] The use of [25] or [26], wherein the gas contains inert gas if the gas contains a gaseous body other than oxygen.
[28] The use of any of [25] to [27], wherein the frozen minced fish meat has a number average minor axis of 1 to 22 mm.
[29] The use of any of [25] to [28], wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.
[30] The use of any of [25] to [29], wherein the gas is made to coexist with the frozen minced fish meat in a package container.
[31] The use of [30], wherein the package container contains a tray and/or a film made of at least one material selected from the group consisting of polyethylene, polypropylene, polyethylene terephthalate, polyamides, an ethylene-vinyl alcohol copolymer, and aluminum.

### DETAILED DESCRIPTION

Conventionally, gas containing oxygen has been filled during the packaging of meat of livestock such as beef, pork, and chicken. This is for binding oxygen to chromoprotein in the meat of livestock to maintain the red color of the meat of livestock. Since oxygen oxidizes lipids, and results in marked quality deterioration, gas containing oxygen has not been filled especially during the packaging of minced meat, having a large surface area. In terms of fish meat, especially fish meat of white meat fishes, the red color does not need to be maintained unlike the meat of livestock.

In such a situation, the present inventor has found that the agglutination of frozen minced fish meat is prevented by daringly making frozen minced fish meat to coexist with gas containing oxygen at a content equal to or higher than a certain content, and thus devised packaged fish meat, frozen minced fish meat, and a method for preventing the agglutination of frozen minced fish meat according to the present disclosure.

It is unknown why the agglutination of the frozen minced fish meat is suppressed with gas containing oxygen at 22% by volume or more. It is conjectured that it is partly because hydrogen bonds that appear to participate in the agglutination between the particles of the frozen minced fish meat are inhibited by oxygen at a high concentration. Hereinafter, the packaged fish meat, the frozen minced fish meat, and the method for preventing the agglutination of frozen minced fish meat according to the present disclosure will be described in detail.

### Packaged Fish Meat

The packaged fish meat of the present disclosure contains frozen minced fish meat and gas containing oxygen at 22% by volume or more as contents.

The gas may contain oxygen at 25% by volume or more, 30% by volume or more, 35% by volume or more, 40% by volume or more, 45% by volume or more, 50% by volume or more, 55% by volume or more, 60% by volume or more, 65% by volume or more, 70% by volume or more, 75% by volume or more, 80% by volume or more, 85% by volume or more, 90% by volume or more, 95% by volume or more, or 100% by volume. If the gas contains oxygen in a suitable amount, the agglutination of the frozen minced fish meat is suppressed.

As used herein, “% by volume” is calculated based on the volumes of multiple gaseous bodies consisting of different pure substances, respectively, (for example, a gaseous body consisting of only oxygen and a gaseous body consisting of only carbon dioxide) before the mixture of the gaseous bodies.

The gas may contain a gaseous body other than oxygen. In the case, the gas may contain inert gas. The term “inert gas” as used here means a gaseous body that does not act on or scarcely acts on the agglutination of the frozen minced fish meat. Examples of the inert gas include, but are not limited to, carbon dioxide, nitrogen, and hydrogen; rare gases (noble gasses) such as helium and argon; and mixed gasses of these.

The gas may contain at least one gaseous body selected from the group consisting of carbon dioxide, nitrogen, and rare gases (noble gasses), or may contain carbon dioxide and/or nitrogen. The gas may contain only oxygen and carbon dioxide from the viewpoint of cost.

The inert gas may be contained at 50% by volume or more, 60% by volume or more, 70% by volume or more, 80% by volume or more, 90% by volume or more, or 100% by volume of the remaining gas obtained by removing oxygen from the gas.

The content of the gas in the packaged fish meat may be any content. The content only has to be typically such a volume that the gas fills the gaps between the particles of the frozen minced fish meat. If the content of the gas is in a suitable range, the agglutination of the frozen minced fish meat can be suppressed while the transport cost is reduced.

As long as the size of the frozen minced fish meat is in a typical range as that of the range of minced meat, the size may be any size. The number average minor axis of the frozen minced fish meat may be 1 mm or more, 2 mm or more, or 3 mm or more. The number average minor axis of the frozen minced fish meat may be 22 mm or less, 15 mm or less, or 7 mm or less.

The upper limit and the lower limit of the number average minor axis that the frozen minced fish meat has can be freely combined in the scope of the present disclosure. That is, the number average minor axis of the frozen minced fish meat may be, for example, 1 to 22 mm, 2 to 15 mm, or 3 to 7 mm.

The term “minor axis” of the frozen minced fish meat as used here means the smallest dimension across among the three-dimensional dimensions of the frozen minced fish meat. If the frozen minced fish meat is roughly columnar, the width of a cross section orthogonal to its axial direction is typically the minor axis in many cases. The minor axis is not, however, limited to this dimension.

As long as the frozen minced fish meat is fish meat that is minced and frozen, the frozen minced fish meat may be any fish meat. For example, fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes can be used as the fish meat.

Examples of the fish belonging to Gadiformes include Gadus macrocephalus, Gadus chalcogrammus, Micromesistius australis, Merluccius, and Macruronus novaezelandiae. Examples of the fish belonging to Aulopiformes include Hime japonica, Saurida macrolepis, Saurida wanieso, and Trachinocephalus myops. Examples of the fish belonging to Siluriformes include Ictalurus punctatus, and Pangasius.

Examples of the fish belonging to Salmoniformes include Oncorhynchus kisutch, Oncorhynchus nerka, Oncorhynchus tshawytscha, Oncorhynchus gorbuscha, Oncorhynchus mykiss, Salvelinus Richardson, Salvelinus fontinalis, Salvelinus leucomaenis, and Thymallus. Examples of the fish belonging to Clupeiformes include Sardinops melanostictus, Clupea pallasii, Engraulis japonicus, Sardinella zunasi, and Konosirus punctatus.

Examples of the fish belonging to Beloniformes include Cololabis saira, Exocoetidae, and Hyporhamphus sajori. Examples of the fish belonging to Beryciformes include Beryx splendens and Beryx decadactylus. Examples of the fish belonging to Scorpaeniformes include Sebastiscus marmoratus, Sebastes inermis, Platycephalus sp., Hexagrammos otakii, and Anoplopoma fimbria.

Examples of the fish belonging to Perciformes include Lateolabrax japonicus, Thunnus, Seriola quinqueradiata, Upeneus japonicus, Oreochromis niloticus, Rachycentron canadum, Trachurus japonicus, Trichiurus lepturus, Coryphaena hippurus, Scomber japonicus, Scomber australasicus, Katsuwonus pelamis, Pagrus major, Nemipterus virgatus, and Pennahia argentata. Examples of the fish belonging to Esociformes include Esox Lucius. Examples of the fish belonging to Pleuronectiformes include Pseudopleuronectes herzensteini, Pseudopleuronectes yokohamae, Reinhardtius hippoglossoides, Hippoglossus stenolepis, and Paralichthys olivaceus.

Fishes not containing large amounts of lipids, which can be deteriorated by oxygen, are typically used. White-meat fishes are typically used. For example, Gadus chalcogrammus, Micromesistius australis, and Macruronus novaezelandiae, belonging to Gadiformes; and Saurida macrolepis, Saurida wanieso, and Trachinocephalus myops, belonging to Aulopiformes, are used. The frozen minced fish meat can be produced, for example, with a meat grinder by the method disclosed in International Publication No. WO 2017/170420.

In the packaged fish meat of the present disclosure, the amount of agglutinated minced fish meat based on the entire amount of the frozen minced fish meat may be 9.5% by mass or less, 9% by mass or less, 8% by mass or less, 7% by mass or less, 6% by mass or less, 5% by mass or less, 4% by mass or less, or 3% by mass or less. The amount of the agglutinated frozen minced fish meat on the entire amount of the frozen minced fish meat can be typically 0.01% by mass or more.

The packaged fish meat of the present disclosure only has to be packaged in a package container to be commonly used for frozen food. For example, the packaged fish meat of the present disclosure may be packaged in a package container including a tray and/or a film made of at least one material selected from the group consisting of polyethylene, polypropylene, polyethylene terephthalate, polyamides, an ethylene-vinyl alcohol copolymer, and aluminum. The packaged fish meat may be packaged in a package container including a tray and/or a film made of a material with high oxygen barrier properties for preventing the release of oxygen.

The size of the package container may be any size. A commercially available package container may have a size of 30 cm×50 cm×5 cm or less. The structure of the package container may be any structure. For example, the package container may have a structure in which an opening in the top surface of a substantially rectangular or substantially truncated quadrangular pyramid-shaped tray is occluded with a film. In the case, a flange may be provided around the opening in the top surface of the tray for facilitating the adhesion of the film to the tray. The package container may be merely a film formed into a substantially rectangular pouch.

After the removal of the atmosphere in the package container storing the frozen minced fish meat, the gas containing oxygen at 22% by volume or more can be filled into the package container, followed by thermal sealing to produce the packaged fish meat of the present disclosure with a food packer that enables gas replacement packaging. The temperature of the frozen minced fish meat during the packaging can be typically 0° C. or less, −3° C. or less, −5° C. or less, −10° C. or less, or −20° C. or less. The packaged fish meat of the present disclosure is stored typically at 0° C. or less, −3° C. or less, −5° C. or less, −10° C. or less, or −20° C. or less.

### Frozen Minced Fish Meat 1

One type of frozen minced fish meat of the present disclosure (frozen minced fish meat 1) is covered with gas containing oxygen at 22% by volume or more. The phrase “covered with the gas containing oxygen at 22% by volume or more” means that the gaps between the particles of the frozen minced fish meat are filled with the gas. Examples of embodiments of the frozen minced fish meat 1 include not only an embodiment in which the gas and the frozen minced fish meat are packaged in the package container but also an embodiment in which the frozen minced fish meat is at least temporarily disposed in an atmosphere of the gas on the production line and an embodiment in which the frozen minced fish meat is at least temporarily disposed in an atmosphere of the gas, for example, at food sections.

The contents of the packaged fish meat mentioned above is applicable, as they are, to the amount of oxygen contained in the gas, the type and the rate of the gaseous body other than oxygen when the gas contains the gaseous body, the size and the number average minor axis of the frozen minced fish meat, the type of the fish for the frozen minced fish meat, and the amount of agglutinated frozen minced fish meat based on the entire amount of the frozen minced fish meat.

The frozen minced fish meat can be mixed with the gas containing oxygen at 22% by volume or more by a well-known method to produce the frozen minced fish meat 1. The temperature of the frozen minced fish meat during the mixture can be typically 0° C. or less, −3° C. or less, −5° C. or less, −10° C. or less, or −20° C. or less.

### Frozen Minced Fish Meat 2

In another type of frozen minced fish meat of the present disclosure (frozen minced fish meat 2), the amount of agglutinated frozen minced fish meat based on the entire amount of the frozen minced fish meat 2 is 9.5% by mass or less. In the frozen minced fish meat 2, the amount of agglutinated frozen minced fish meat based on the entire amount of the frozen minced fish meat 2 may be 9% by mass or less, 8% by mass or less, 7% by mass or less, 6% by mass or less, 5% by mass or less, 4% by mass or less, or 3% by mass or less. The amount of agglutinated frozen minced fish meat based on the entire amount of the frozen minced fish meat can be typically 0.01% by mass or more.

The amount of agglutinated frozen minced fish meat can be measured, for example, by sieving. For example, if the number average minor axis of unagglutinated frozen minced fish meat is 3 to 7 mm, the agglutinated frozen minced fish meat may be determined as that of not passing through a sieve with an aperture of 7 to 8 mm (sieve with a minimum aperture of 7 mm and a maximum aperture of 8 mm). As the sieve with an aperture of 7 to 8 mm, a sieve such as “Senkichi®, Stainless-Steel Soil Sieve 30 CM, Mesh Size: Coarse Mesh” (available from Fujiwara Industrial Co., Ltd.) (round stainless-steel sieve with a size 30 cm in diameter and 7 cm in height) may be used.

The frozen minced fish meat can be mixed with the gas containing oxygen at 22% by volume or more by a well-known method to produce the frozen minced fish meat 2. The temperature of the frozen minced fish meat during the mixture can be typically 0° C. or less, −3° C. or less, −5° C. or less, −10° C. or less, or −20° C. or less.

The contents of the packaged fish meat mentioned above is applicable, as they are, to the amount of oxygen contained in the gas, the type and the rate of the gaseous body other than oxygen if the gas contains the gaseous body, the size and the number average minor axis of the frozen minced fish meat, and the type of the fish for the frozen minced fish meat.

### Method for Preventing Agglutination of Frozen Minced Fish Meat

In the method for preventing the agglutination of frozen minced fish meat, the frozen minced fish meat is made to coexist with gas containing oxygen at 22% by volume or more.

The contents of the packaged fish meat mentioned above is applicable, as they are, to the amount of oxygen contained in the gas, the type and the rate of the gaseous body other than oxygen if the gas contains the gaseous body, the size and the number average minor axis of the frozen minced fish meat, and the type of the fish for the frozen minced fish meat. The temperature of the frozen minced fish meat during the coexistence of the frozen minced fish meat with the gas can be typically 0° C. or less, −3° C. or less, −5° C. or less, −10° C. or less, or −20° C. or less.

Examples of embodiments of the method of the present disclosure for preventing the agglutination of the frozen minced fish meat include, but not particularly limited to, an embodiment in which the frozen minced fish meat is at least temporarily disposed in an atmosphere of the gas on the production line, an embodiment in which the frozen minced fish meat is at least temporarily disposed in an atmosphere of the gas at food sections of, for example, grocery stores, and an embodiment in which the frozen minced fish meat is made to coexist with the gas in the package container. If the embodiment in which the frozen minced fish meat is made to coexist with the gas in the package container is adopted, the contents of the packaged fish meat mentioned above are applicable to the package container as they are.

### Specified Method for Using Gas Containing Oxygen at 22% by Volume or More

The present disclosure also discloses that gas containing oxygen at 22% by volume or more is used for preventing the agglutination of frozen minced fish meat.

The contents of the packaged fish meat mentioned above is applicable, as they are, to the amount of oxygen contained in the gas, the type and the rate of the gaseous body other than oxygen when the gas contains the gaseous body, the size and the number average minor axis of the frozen minced fish meat, and the type of the fish for the frozen minced fish meat. The temperature of the frozen minced fish meat during the use of the gas can be typically 0° C. or less, −3° C. or less, −5° C. or less, −10° C. or less, or −20° C. or less.

Examples of embodiments of the use of the gas containing oxygen at 22% by volume or more include, but not particularly limited to, an embodiment in which the frozen minced fish meat is at least temporarily disposed in an atmosphere of the gas on the production line, an embodiment in which the frozen minced fish meat is at least temporarily disposed in an atmosphere of the gas, for example, at food sections, and an embodiment in which the frozen minced fish meat is made to coexist with the gas in the package container. If the embodiment in which the frozen minced fish meat is made to coexist with the gas in the package container is adopted, the contents of the packaged fish meat mentioned above are applicable to the package container as they are.

The specified items described in an embodiment of the aspects of the present disclosure herein may be optionally combined into new embodiments. It should be understood that such new embodiments can also be included in the aspects of the present disclosure.

### EXAMPLES

Hereinafter, the present disclosure will be described further specifically by Examples, but the present disclosure is not limited by these Examples at all.

Frozen minced fish meat of Gadus chalcogrammus containing particles having a substantially columnar shape with a minor axis of 3 to 7 mm at 90% by mass or more and having a number average minor axis in the range of 3 to 7 mm was produced based on the disclosure of International Publication No. 2017/170420. Packaged fish meat storing the frozen minced fish meat was produced using TFS-100, which is available from ULMA, as a food packer. As the material of the package container, a multi-layer film containing polyethylene, polyamide, and an ethylene-vinyl alcohol copolymer (Mitsubishi Chemical Corporation, DIAMIRON MF C6 type, thickness: 150 μm) as a bottom material and a multi-layer film containing polyethylene, polyamide, polypropylene, and an ethylene-vinyl alcohol copolymer as a lid material (Mitsubishi Chemical Corporation, DIAMIRON L367, thickness: 80 μm) were used. At that time, the pressure was reduced to 15 hPa (15 mbar), and each of the gases A to C described in the following Table 1 were thereafter filled at a filling pressure of 0.4 MPa or less, followed by thermal sealing using deep drawing. The atmosphere temperature during the packaging was 18° C., and the temperature of the frozen minced fish meat was −5 to −3° C. As Comparative Example 1, frozen minced fish meat was fed to a package container, and the atmosphere was thereafter removed by tapping to seal the package container, so that a conventional packaged fish meat was produced.

TABLE 1

| | Filled gas |
|---|---|
| Comparative | The atmosphere |
| Example 1 | |
| Example 1 | Gas A (oxygen at 30% by volume/carbon |
| | dioxide at 70% by volume) |
| Example 2 | Gas B (oxygen at 50% by volume/carbon |
| | dioxide at 50% by volume) |
| Example 3 | Gas C (oxygen at 100% by volume) |

The packaged fish meats of Examples 1 to 3 and Comparative Example 1 were stored at −5° C. for 14 days and thereafter opened, and the frozen minced fish meat of each package was fed to a sieve with an aperture of 7 to 8 mm (“Senkichi®, Stainless-Steel Soil Sieve 30 CM, Mesh Size: Coarse Mesh”, which was available from Fujiwara Industrial Co., Ltd.). It was determined that particles not passed through the sieve were agglutinated, and the rates of the agglutinated particles were calculated as shown in the following Table 2. In any of Examples, oxygen was not observed to influence lipids. It was determined from oxidized odor emitted at the time of oxidization of the lipids in the fish meat whether oxygen influenced the lipids or not.

TABLE 2

| | Amount of agglutinated |
|---|---|
| | particles (% by mass) |
| Comparative | 9.8 |
| Example 1 | |
| Example 1 | 5.6 |
| Example 2 | 3.3 |
| Example 3 | 2.5 |

Packaged fish meat, frozen minced fish meat, and a method for preventing the agglutination of frozen minced fish meat of the present disclosure are suitably available in industrial fields of foods using frozen minced fish meat.

What is claimed is:

1. Packaged fish meat, comprising:
frozen minced fish meat and
gas comprising oxygen at 22% by volume or more as contents.

2. The packaged fish meat according to claim 1, wherein the gas comprises oxygen at 30% by volume or more.

3. The packaged fish meat according to claim 1, wherein the gas comprises inert gas if the gas comprises a gaseous body other than oxygen.

4. The packaged fish meat according to claim 1, wherein the frozen minced fish meat has a number average minor axis of 1 to 22 mm.

5. The packaged fish meat according to claim 1, wherein an amount of agglutinated frozen minced fish meat based on an entire amount of the frozen minced fish meat is 9.5% by mass or less.

6. The packaged fish meat according to claim 1, wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.

7. The packaged fish meat according to claim 1, wherein the packaged fish meat is packaged in a package container comprising a tray and/or a film made of at least one material selected from the group consisting of polyethylene, polypropylene, polyethylene terephthalate, polyamide, an ethylene-vinyl alcohol copolymer, and aluminum.

8. Frozen minced fish meat, wherein an amount of agglutinated frozen minced fish meat based on an entire amount of the frozen minced fish meat is 9.5% by mass or less.

9. The frozen minced fish meat according to claim 8, wherein unagglutinated frozen minced fish meat has a number average minor axis of 3 to 7 mm, and the agglutinated frozen minced fish meat does not pass through a sieve with an aperture of 7 to 8 mm.

10. The frozen minced fish meat according to claim 9, wherein the sieve is a round stainless-steel sieve with a size of 30 cm in diameter and 7 cm in height, a minimum aperture of 7 mm, and a maximum aperture of 8 mm.

11. The frozen minced fish meat according to claim 8, wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.

12. A method for preventing agglutination of frozen minced fish meat, wherein frozen minced fish meat is made to coexist with gas comprising oxygen at 22% by volume or more.

13. The method according to claim 12, wherein the gas comprises oxygen at 30% by volume or more.

14. The method according to claim 12, wherein the gas comprises inert gas if the gas comprises a gaseous body other than oxygen.

15. The method according to claim 12, wherein the frozen minced fish meat has a number average minor axis of 1 to 22 mm.

16. The method according to claim 12, wherein the frozen minced fish meat is fish meat of a fish or fishes belonging to at least one selected from the group consisting of Gadiformes, Aulopiformes, Siluriformes, Salmoniformes, Clupeiformes, Beloniformes, Beryciformes, Scorpaeniformes, Perciformes, Esociformes, and Pleuronectiformes.

17. The method according to claim 12, wherein the frozen minced fish meat is made to coexist with the gas in a package container.

18. The method according to claim 17, wherein the package container comprises a tray and/or a film made of at least one material selected from the group consisting of polyethylene, polypropylene, polyethylene terephthalate, polyamide, an ethylene-vinyl alcohol copolymer, and aluminum.
